(19) United States
(12) Patent Application Publication
(10) Pub. No.: US 2005/0279792 A1
(43) Pub. Date: Dec. 22, 2005

(54) Machine for automatic water to biker

(76) Inventor: Mark Steven Batchelor, Collegeville, PA (US)

Correspondence Address: Mark Batchelor, 296 Carmen Drive, Collegeville, PA, 19426, US

(21) Appl. No.: 10/872,705

(22) Filed: Jun. 21, 2004

(51) Int. Cl. B62J 11/00

(52) U.S. Cl. 224/414

(57) ABSTRACT

A machine for automatic water to biker with The bike rider only has to lean in to an extended small hose that is attached to the front and center of the bike, then can still focus on riding while depressing the button and the water will be pumped into his mouth, and water spayed on his face if he so desires a cooling of water instead of a drink.

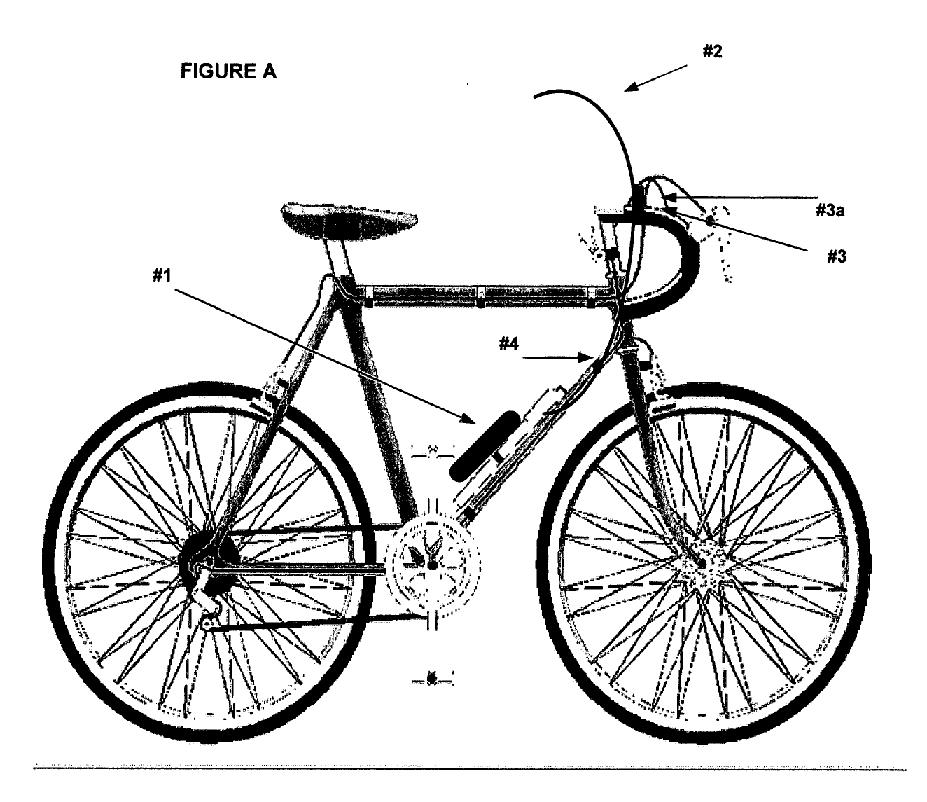

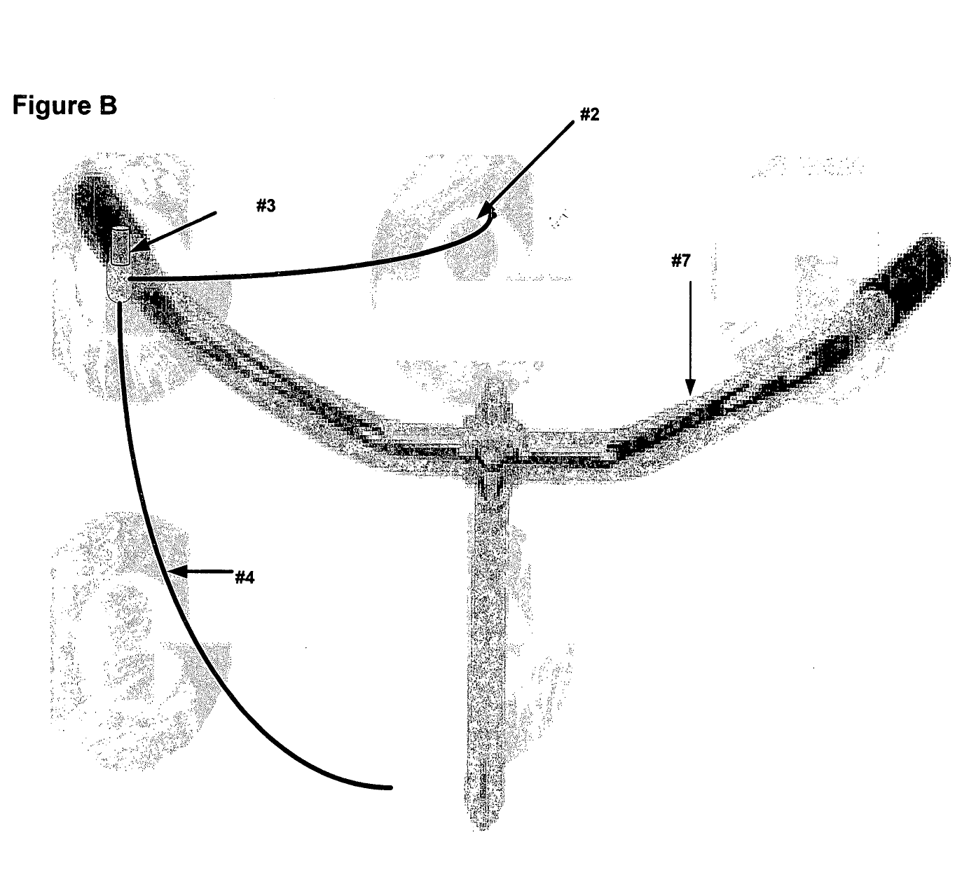

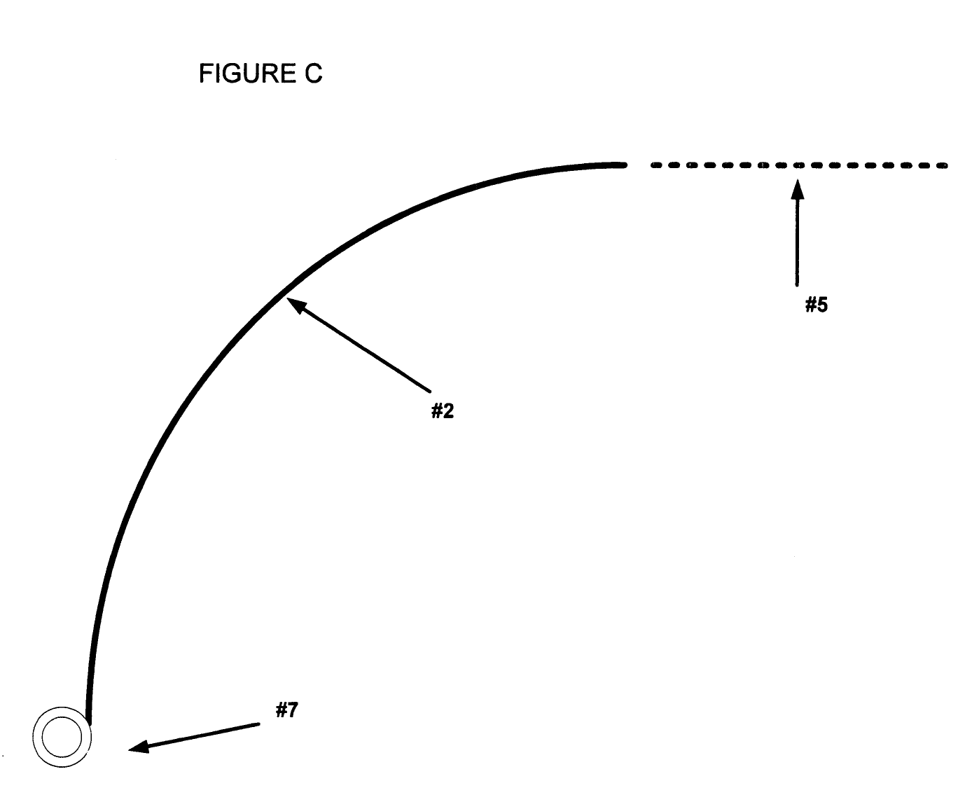

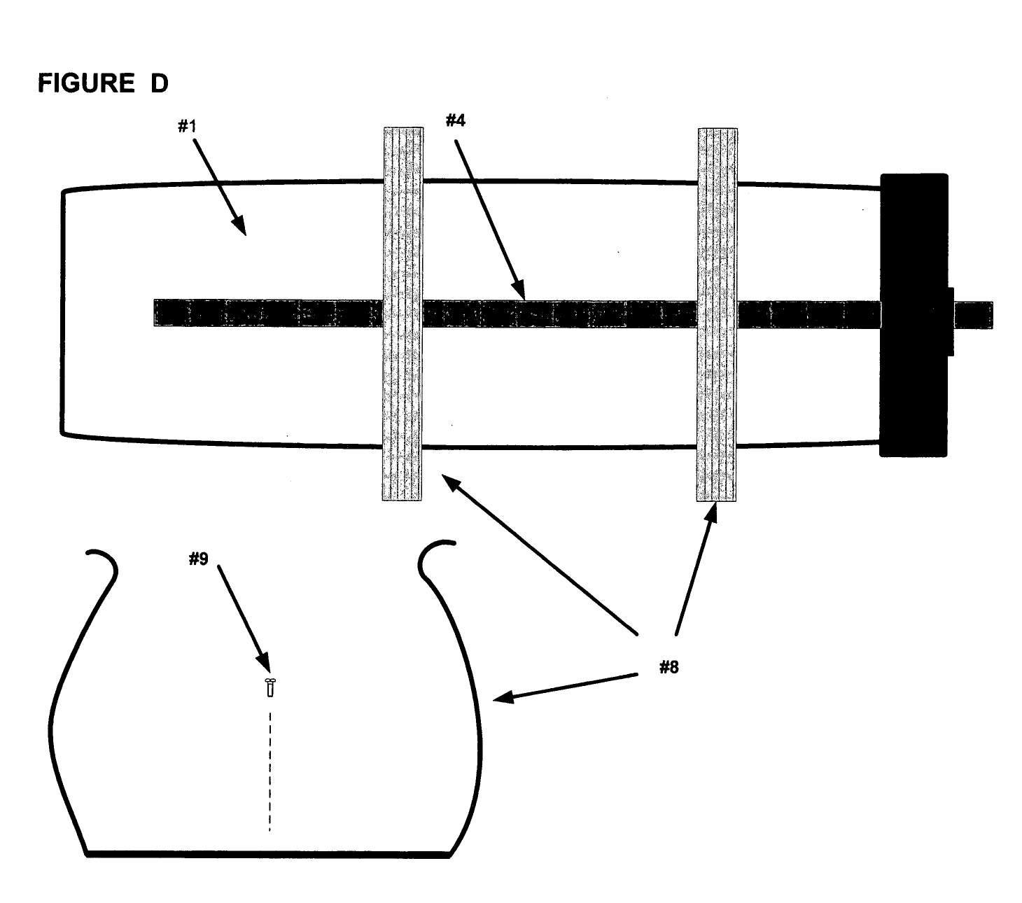

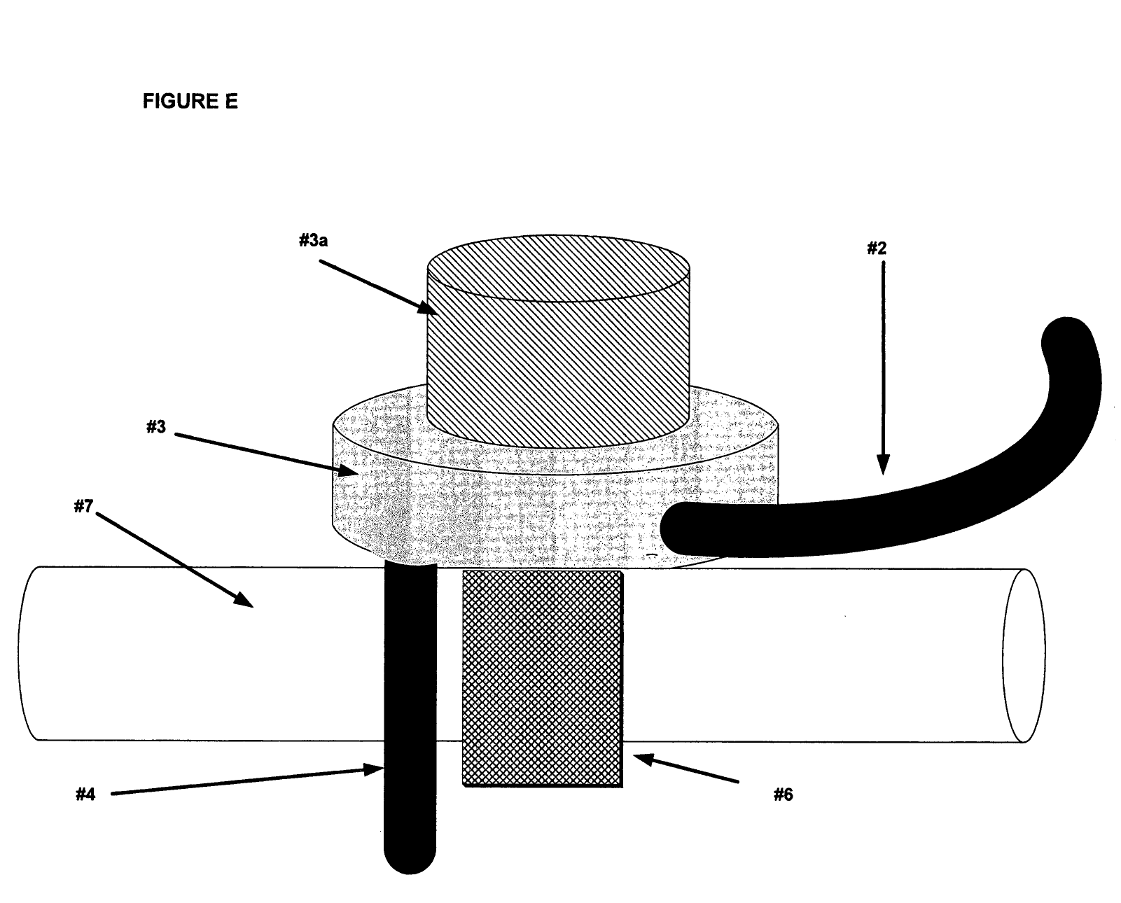

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of the sport of bicycling and more specifically to a machine for automatic water to biker.

This invention is the only safe and effective way of drinking water and cooling down with maintaining focus on riding a bicycle. All other water holding devices require lifting and reaching for water and taking you eyes off the road while riding, sometimes requiring the biker to stop riding to get a drink of water. This invention is concerned with safely and provides a safe way a quick way to provide drinking water from novice bikers or professionals. Poor technology in present water bottles is all just water bottles that mount on bike and have no easy way to retrieve them for drinking other that reaching for them. These old technologies are unsafe to use for anyone riding a bike.

### BRIEF SUMMARY OF THE INVENTION

The primary object of the invention is The benefit of this invention is that a bicycle rider, while riding can provide water to drink.

Another object of the invention is while riding can cool down.

Another object of the invention is to lean forward and depress button on handle bar with thumb. Another object is to provide a safe ride while drinking water.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for automatic water to biker comprising: The bike rider only has to lean in to an extended small hose that is attached to the front and center of the bike, then he can still focus on riding while depressing the button and the water will be pumped into his mouth, or water spayed on his face if he so desires a cooling of water instead of a drink.

In accordance with a preferred embodiment of the invention, there is disclosed-a machine for automatic water to biker comprising: The bike rider only has to lean in to an extended-small-hose that is attached to-the-front and center of the bike, then can-still focus on riding while depressing the button and the water will be pumped into his mouth and water spayed on his face if he so desires a cooling of water instead of a drink.

In accordance with a preferred embodiment of the invention, there is disclosed a machine for automatic water to biker comprising: The bike rider only has to lean in to an extended small hose that is attached to the front and center of the bike, then can still focus on riding while depressing the button and the water will be pumped into his mouth, and water spayed on his face if he so desires a cooling of water instead of a drink. Turning to the drawings as so far described in Figure A thus it is seen that the water bottle assembly can provide all the above mentioned. It is obvious that the bike rider requires little or no effort too drink water while riding or to spray water without risking falling. It is found in practice to be a perfect way of supplying water to a bike rider while riding.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Figure A is a perspective view of the invention.

Figure B is a perspective view of the invention.

Figure C is a perspective view of the invention.

Figure D is a perspective view of the invention.

Figure E is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning to figure A, there the machine is shown the water bottle assembly attached to the bike.

Turning to figure B, there it is shown the pump item #3 and #3a on the the handle bar item #7, that only by depressing with the bikers thumb on item #3a can pump water from item #4, the hose from the water bottle pumped through item number #3 and 3a, the pump button, and water would be dispersed through item #2.

In accordance with the present invention, Figure C shows where the water item #5 is exited automatically from tube labeled #2 the biker can now lean forward while riding for cooling by spraying or to drink the water easily in front of him, because of the extended tube on the handle bar.

Turning to figure D, there the machine water bottle assembly is shown as item #1 with brackets to hold to bike as shown as item #8.

Turning to figure A there the machine is shown as item #3 and #3a the water pump by depressing item #3a would force water from through item #2 the exit tube. Item #6 is the bracket to hold item #3 onto handle bar #7, pumping water from bottle on Figure A item #1 through item #4 to Item #2 exiting to into bike rider mouth or sprayed onto face.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine for automatic water to biker comprising:
The bike rider only has to lean in to an extended small hose that is attached to the front and center of the bike;
then can still focus on riding while depressing the button and the water will be pumped into his mouth; and
water spayed on his face if he so desires a cooling of water instead of a drink.

2. A machine for automatic water to biker comprising:
The bike rider only has to lean in to an extended small hose that is attached to the front and center of the bike, does not have to reach for a bottle underneath of him which would create an unsafe situation.

3. A machine for automatic water to biker comprising:
The bike rider can maintain his focus and speed for the purpose of refreshing himself without risking falling or slowing down.
